(19) United States
(12) Patent Application Publication
(10) Pub. No.: US 2016/0111742 A1
(43) Pub. Date: Apr. 21, 2016

(54) METHODS OF REMOVING HYDROGEN SULFIDE AND GENERATING ELECTRICITY USING ALKALINE SULFIDE FUEL CELL

(71) Applicant: KOREA ADVANCED INSTITUTE OF SCIENCE AND TECHNOLOGY, Daejeon (KR)

(72) Inventors: Jong-In Han, Daejeon (KR); Kwiyong Kik, Daejeon (KR)

(73) Assignee: KOREA ADVANCED INSTITUTE OF SCIENCE AND TECHNOLOGY, Daejeon (KR)

(21) Appl. No.: 14/713,932

(22) Filed: May 15, 2015

(30) Foreign Application Priority Data
Oct. 20, 2014 (KR) 10-2014-0141827

(51) Int. Cl. H01M 8/06; H01M 8/10

(52) U.S. Cl. CPC H01M 8/06; H01M 8/1009; H01M 2008/1095; H01M 2300/0082

(57) ABSTRACT

The present invention relates to a method for removing hydrogen sulfide, which comprises absorbing hydrogen sulfide into an alkaline solution, and introducing the solution resulting from the absorption into the anode of a fuel cell to oxidize sulfide ion. The method comprises a step of absorbing hydrogen sulfide into an alkaline solution. In a fuel cell, electrical energy is produced from the alkaline sulfide solution resulting from the absorbing step. Thus, according to the present invention, the cost and efficiency problems occurring in conventional hydrogen sulfide removal processes are solved.

### CROSS-REFERENCE TO RELATED APPLICATION

This application claims priority under the provisions of 35 USC 119 to Korean Patent Application No. 10-2014-0141827 filed Oct. 20, 2014. The disclosure of Korean Patent Application No. 10-2014-0141827 is hereby incorporated herein by reference, in its entirety, for all purposes.

### TECHNICAL FIELD

The present invention relates to a method for removing hydrogen sulfide, and more particularly, to a method of removing hydrogen sulfide while producing electrical energy using an alkaline solution containing sulfide ion as a fuel, and a method of increasing the production of electrical energy using an electrocatalyst.

### BACKGROUND ART

Hydrogen sulfide is a toxic, corrosive gas that naturally occurs or is generated by industrial activity. Hydrogen sulfide is generated in large amounts in processes necessary for human survival, for example, processes for refining of petroleum for energy production, and anaerobic digestion processes for sewage treatment.

The annual generation of hydrogen sulfide in the world is currently estimated to be 250 million tons, and is expected to increase continuously. Thus, it is important to secure technology for effectively removing hydrogen sulfide.

Among processes for removing hydrogen sulfide, the most common process is the Claus process. The Claus process shows a hydrogen sulfide removal rate, and thus has already been widely used, but has problems in economic terms, because it requires high initial installation costs and high-temperature and high-pressure operating conditions. In addition, hydrogen that is an exhaust gas generated during the process contains corrosive byproducts such as CS₂, SO₂ or COS, and thus is not effectively used. Accordingly, it is required to develop a process that can remove hydrogen sulfide while minimizing energy consumption, and can produce energy, if possible.

The removal of hydrogen sulfide using a fuel cell has been suggested as an alternative to the Claus process. In particular, a platform based on a solid oxide fuel cell, which is operated at a high temperature of 500° C. or higher, or a polymer electrolyte fuel cell which is operated at a temperature lower than 100° C., was developed, and it was reported to remove hydrogen sulfide by oxidizing it using the fuel cell while producing electrical energy. However, it is known that the performance of the fuel cell chronically decreases due to the poisoning of electrode materials (including catalysts) by the corrosive and toxic nature of hydrogen sulfide itself. In addition, it is known that, because this poisoning phenomenon causes a rapid decrease in the performance of the fuel cell within 1 hour after the start of operation of the fuel cell, it is relatively difficult to securely produce electrical energy using hydrogen sulfide as fuel. In view of this fact, recent studies have been conducted on the development of electrode catalysts having resistance to hydrogen sulfide, but are still insufficient for commercialization.

Accordingly, the present inventors have made extensive efforts to solve the above-described problems, and as a result, have found that, if hydrogen sulfide is absorbed into an alkaline solution in a hydrogen sulfide removal process, it can be removed at a rate of 100%, and if the resulting solution containing produced sulfide ions is fed into the anode of a fuel cell, electricity can be produced. In addition, the present inventors have found that, if the alkaline solution containing sulfide ions is used as fuel, the fuel cell can exhibit its performance over a long period of time without poisoning of the electrode, thereby completing the present invention.

### PRIOR ART LITERATURE

### Patent Documents

Patent document 1: P. W. Bolmer, Electrochemical oxidation of hydrogen sulfide, U.S. Pat. No. 3,249,522.

Patent document 2: R. Zito, L. J. Kunz, Method of operating a fuel cell using sulfide fuel, U.S. Pat. No. 3,920,474.

### Non-Patent Documents

Non-Patent Document 1: Liu M, He P, Luo J L, Sanger A R, Chuang K T. Performance of a solid oxide fuel cell utilizing hydrogen sulfide as fuel. J Power Sources 2001;94:20-5.

Non-Patent Document 2: He P, Liu M, Luo J L, Sanger A R, Chuang K T. Stabilization of platinum anode catalyst in a H2S-O2 solid oxide fuel cell with an intermediate TiO2 layer. JElectrochem Soc 2002;149:A808-14.

Non-Patent Document 3: Slavov S V, Chuang K T, Sanger A R, Donini J C, Kot J, Petrovic S. A proton-conducting solid state H2S-O2 fuel cell. 1. Anode catalysts, and operation at atmospheric pressure and 20-90. Int J Hydrogen Energy 1998;23:1203-12.

Non-Patent Document 4: Chuang K T, Donini J C, Sanger A R, Slavov S V. A proton-conducting solid state H2S-O2 fuel cell. 2. Production of liquid sulfur at 120-145. Int J Hydrogen Energy 2000;25:887-94.

### SUMMARY OF INVENTION

It is an object of the present invention to develop a fuel cell that can remove hydrogen sulfide and, at the same time, can securely produce electrical energy over a long period of time without poisoning by using an alkaline sulfide solution as a fuel for the fuel cell, and to provide a method of increasing the production of electrical energy using various electrocatalysts.

To achieve the above objects, the present invention provides a method for removing hydrogen sulfide, the method comprising the steps of: (a) absorbing hydrogen sulfide into an alkaline aqueous solution to produce sulfide ion; and (b) electrochemically oxidizing the solution containing the sulfide ion produced in step (a) to thereby produce sulfate ion.

The present invention also provides a hydrogen sulfide removal system comprising: an H₂S absorption unit including an alkaline aqueous solution and configured to absorb hydrogen sulfide to produce sulfide ion; and a fuel cell unit configured to oxidize the solution containing the sulfide ion produced in the absorption unit.

The present invention also provides a method for removing hydrogen sulfide and generating electricity, the method comprising the steps of: (a) absorbing hydrogen sulfide into an alkaline aqueous solution to produce sulfide ion; and (b) feeding the solution containing the sulfide ion produced in step (a) into an anode of a fuel cell and producing sulfate ion to thereby produce electrical energy.

The present invention also provides a fuel cell system comprising: an H₂S absorption unit including an alkaline aqueous solution and configured to absorb hydrogen sulfide to produce sulfide ion; and a fuel cell unit configured to oxidize the solution containing the sulfide ion produced in the absorption unit to thereby generate electricity.

### BRIEF DESCRIPTION OF THE DRAWINGS

FIG. 1 is an overall schematic view of the present invention.

FIGS. 2A and 2B are a set of graphs, showing the removal rate calculated as the concentration of discharged hydrogen sulfide (FIG. 2A), and a time-dependent increase in the concentration of dissolved sulfide ions (FIG. 2B), when 1000 ppm of hydrogen sulfide was absorbed into an alkaline aqueous solution of NaOH at a rate of 500 ml/min.

FIGS. 3A to 3C are graphs showing voltage-current curves and power density curves, measured to examine the influence of various variables when a direct alkaline sulfide fuel cell according to the present invention has no electrocatalyst for the anode. FIG. 3A: influence of alkalinity; FIG. 3B: influence of sulfide ion concentration; FIG. 3C: influence of temperature. FIG. 3D shows the influence of the presence or absence of a platinum catalyst.

FIGS. 4A and 4B are a set of graphs showing a current density as a function of alkalinity, measured when a direct alkaline sulfide fuel cell was operated for 8 hours in the absence of an electrocatalyst for the anode (FIG. 4A), and final products as a function of alkalinity (FIG. 4B).

FIGS. 5A to 5C show SEM photographs of the electrode surface, taken before the operation of a direct alkaline sulfide fuel cell according to the present invention (FIG. 5A), and after the 8-hour operation of the fuel cell in the absence of an electrocatalyst for the anode (FIG. 5B). FIG. 5C is the EDX spectrum of the electrode surface after the 8-hour operation of the fuel cell.

FIGS. 6A and 6B show voltage-current curves and power density-current curves (FIG. 6A) and impedance curves (FIG. 6B), measured for each amount of coating of platinum when varying amounts of platinum was used as an electrocatalyst for the anode in a direct alkaline sulfide fuel cell according to the present invention.

FIG. 7 is a lifespan graph showing the results of measuring the voltage output over 30 hours for each amount of coating of platinum when varying amounts of platinum was used as an electrocatalyst for the anode in a direct alkaline sulfide fuel cell according to the present invention.

FIG. 8 is an XRD graph of a platinum-loaded electrode, measured after 30 hours of lifespan evaluation when platinum was used as an electrocatalyst for the anode in a direct alkaline sulfide fuel cell according to the present invention.

FIGS. 9A and 9B show voltage-current curves and power density-current curves (FIG. 9A) and impedance curves (FIG. 9B), measured for each metal when various metal sulfides were used as electrocatalysts for the anode in a direct alkaline sulfide fuel cell according to the present invention.

FIGS. 10A and 10B show voltage-current curves and power density-current curves (FIG. 10A) and impedance curves (FIG. 10B), measured for each heteropolyacid when various heteropolyacids were used as electrocatalysts for the anode in a direct alkaline sulfide fuel cell according to the present invention.

FIG. 11 is a lifespan graph showing the results of measuring the voltage output over 10 hours for each heteropolyacid when various heteropolyacids were used as electrocatalysts for the anode in a direct alkaline sulfide fuel cell according to the present invention.

FIGS. 12A and 12B show cyclic voltammetric curves for 3 M NaOH solution (FIG. 12A) and cyclic voltammetric curves for 1 M Na₂S+3 M NaOH solution (FIG. 12B), measured for various palladium/cobalt ratios when a palladium-cobalt binary alloy was used as an electrocatalyst for the anode in a direct alkaline sulfide fuel cell according to the present invention.

FIGS. 13A and 13B show voltage-current curves and power density-current curves (FIG. 13A) and impedance curves (FIG. 13B), measured for various palladium/cobalt ratios when a palladium-cobalt binary alloy was used as an electrocatalyst for the anode in a direct alkaline sulfide fuel cell according to the present invention.

### BEST MODE FOR CARRYING OUT THE INVENTION

Unless defined otherwise, all technical and scientific terms used herein have the same meaning as commonly understood by one of ordinary skill in the art to which the invention pertains. Generally, the nomenclature used herein and the experiment methods, which will be described below, are those well known and commonly employed in the art.

The present inventors have attempted to confirm that, when a direct alkaline sulfide fuel cell is used, sulfide ion can be oxidized to sulfate ion and removed while producing electricity. In addition, the present inventors have attempted to confirm that the direct alkaline sulfide fuel cell can be operated for a long period of time without poisoning, unlike other fuel cells that employ hydrogen sulfide, and to improve the performance of the fuel cell using an electrocatalyst.

Therefore, in an aspect, the present invention is directed to a method for removing hydrogen sulfide, the method comprising the steps of: (a) absorbing hydrogen sulfide into an alkaline aqueous solution to produce sulfide ion; and (b) electrochemically oxidizing the solution containing the sulfide ion produced in step (a) to thereby produce sulfate ion.

In the method for removing hydrogen sulfide according to the present invention, hydrogen sulfide is absorbed into an alkaline aqueous solution to convert the toxic gas to ionic species and remove the toxic gas, and the resulting solution is fed into the anode of a fuel cell to produce electrical energy and oxidize the sulfide ion to sulfate ion.

The alkaline aqueous solution for providing alkaline conditions may be an aqueous solution of an alkaline metal salt. In a preferred embodiment, it may be selected from the group consisting of sodium hydroxide (NaOH) and potassium hydroxide (KOH). Also, the concentration of the alkaline aqueous solution may be 0.1-10 M, and preferably 1-5 M.

In the step of electrochemically oxidizing the solution, the solution containing the sulfide ion may be used as an electrolytic solution in the anode of the fuel cell. The pH of the solution in step (b) may be 9-14, and preferably 12-14. If the pH of the solution in step (b) is lower than 9, the sulfide ion will not be oxidized to sulfate ion, and will remain in the form of sulfur on the electrode, thus causing the accumulation of sulfur on the electrode. The pH of the solution in step (b) is maintained at the highest possible level so as to increase the oxidation rate of the sulfide ion and maximize the production of electrical energy. Under acidic or neutral conditions, sulfide ion is oxidized only to sulfur, but under alkaline conditions, sulfide ion is further oxidized to sulfate ion such as S₂O₃²⁻, SO₃²⁻ or SO₄²⁻, which consists of sulfur bonded to oxygen, and this sulfate ion may be used as a value-added material in various industrial fields. Thus, the pH of the solution in step (b) is maintained at a high level so that the production of this value-added material will be maximized.

In the fuel cell that is used in step (b), the concentration of the sulfide ion is maintained at the highest possible level so that the production of electrical energy will be maximized. Conventional fuels such as methanol have a crossover problem, but the crossover of sulfide ion across a Nafion membrane does not occur, and thus the sulfide ion causes no pressure drop.

The fuel cell in step (b) may be operated at a temperature between 20° C. and 90° C. As the operating temperature increases, the reaction rate increases so that the production of electrical energy will be increased.

The fuel cell that is used in step (b) will not be poisoned, and thus can be securely operated, unlike other fuel cells that use hydrogen sulfide as fuel. Thus, it can be seen that, when the solution resulting from step (a) is fed into the anode of the fuel cell after which an external resistor is connected to the anode, the fuel cell can be securely operated over a long period of time. Particularly, it was found that a platinum catalyst known to be susceptible to poisoning is stable even in the presence of an alkaline sulfide solution fed as fuel.

In the fuel cell that is used in step (b), various electrocatalysts may be used to increase the oxidation rate of sulfide ion. The electrocatalyst may be one or more selected from the group consisting of a noble metal, a transition metal, a noble metal oxide, a transition metal oxide, a noble metal sulfide, a transition metal sulfide, a noble metal-transition metal binary alloy, and a heteropolyacid and its salt. Preferably, the electrocatalyst may be selected in view of economic merits, but is not limited thereto.

The noble metal may be gold, silver, platinum or palladium; the transition metal may be nickel, cobalt, iron, manganese, molybdenum or tungsten; and the heteropolyacid and its salt may be one or more selected from the group consisting of molybdophosphate (PMo₁₂O₄₀³⁻), tungsten phosphate (PW₁₂O₄₀³⁻), molybdosilicate (SiMo₁₂O₄₀⁴⁻) and tungsten silicate (SiW₁₂O₄₀⁴⁻). Preferably, molybdophosphate is used, but is not limited thereto. In addition, a compound obtained by substituting a portion of the molybdenum (Mo) or tungsten (W) of the heteropolyacid with vanadium (V) may also be used.

In a preferred embodiment, platinum, a metal sulfide such as molybdenum sulfide, iron sulfide or cobalt sulfide, a heteropolyacid such as molybdophosphate, tungsten phosphate or silicon tungstate, or a binary alloy such as palladium-cobalt may be used, but is not limited thereto. When an anode coated with a platinum catalyst was used, the production of electrical energy increased as the amount of catalyst coated increased, the suitable amount of catalyst coated can be determined in view of costs.

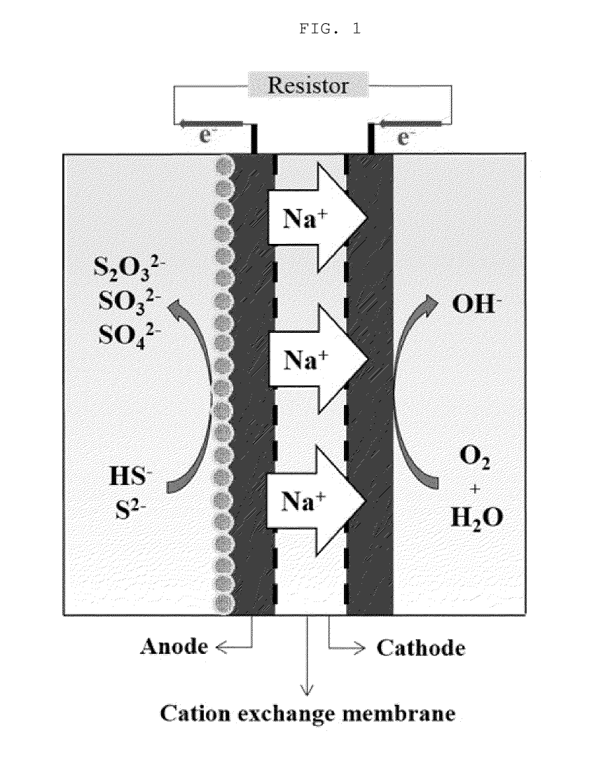

FIG. 1 shows an example of a direct alkaline sulfide fuel cell that uses as fuel the solution resulting from step (a). The fuel cell shown in FIG. 1 is intended to illustrate the present invention, and a fuel cell that is actually used in the present invention is not limited to the fuel cell of FIG. 1.

The fuel cell comprises an anode, a cathode, and an ion-exchange membrane interposed therebetween. The anode and cathode of the fuel cell may be made of any material that is generally used as an electrode material for conventional fuel cells. The ion-exchange membrane may be a Nafion membrane substituted with sodium or potassium depending on the kind of cation of the salt for providing alkaline conditions.

The hydrogen sulfide removal process according to the present invention consists largely of two units: an absorption unit, and a fuel cell unit. The absorption unit (not shown in FIG. 1) is a process intended to completely absorb gaseous hydrogen sulfide into an alkaline aqueous solution so that a gas discharged from the absorption unit contains no hydrogen sulfide. A reactor that is used in the absorption process should be able to maximize the time of contact between the fed gas and the solution to thereby enable hydrogen sulfide to be actively transported to the solution.

In the anode of the fuel cell, a reaction occurs in which the sulfide ion produced by the absorption of hydrogen sulfide into the alkaline aqueous solution is electrochemically oxidized on the electrode to produce sulfate ion.

Meanwhile, in the cathode, a reaction occurs in which water fed from the anode, electrons from an external circuit, and oxygen are bonded to each other and reduced to hydroxyl groups. The reactions in the anode and the cathode are fuel cell reactions that enable the production of electrical energy from the oxidation of hydrogen sulfide.

In another aspect, the present invention is directed to a hydrogen sulfide removal system comprising: an H₂S absorption unit including an alkaline aqueous solution and configured to absorb hydrogen sulfide to produce sulfide ion; and a fuel cell unit configured to oxidize the solution containing the sulfide ion produced in the absorption unit.

In still another aspect, the present invention is directed to a method for removing hydrogen sulfide and generating electricity, the method comprising the steps of: (a) absorbing hydrogen sulfide into an alkaline aqueous solution to produce sulfide ion; and (b) feeding the solution containing the sulfide ion produced in step (a) into an anode of a fuel cell and producing sulfate ion to thereby produce electrical energy.

In yet another aspect, the present invention is directed to a fuel cell system comprising: an H₂S absorption unit including an alkaline aqueous solution and configured to absorb hydrogen sulfide to produce sulfide ion; and a fuel cell unit configured to oxidize the solution containing the sulfide ion produced in the absorption unit to thereby generate electricity.

According to the present invention, a toxic gas such as hydrogen sulfide can be removed using the fuel cell while producing electrical energy to realize energy self-sufficiency.

Hereinafter, the present invention will be described in further detail with reference to examples. It will be obvious to a person having ordinary skill in the art that these examples are illustrative purposes only and are not to be construed to limit the scope of the present invention. Thus, the substantial scope of the present invention will be defined by the appended claims and equivalents thereof.

### Example 1

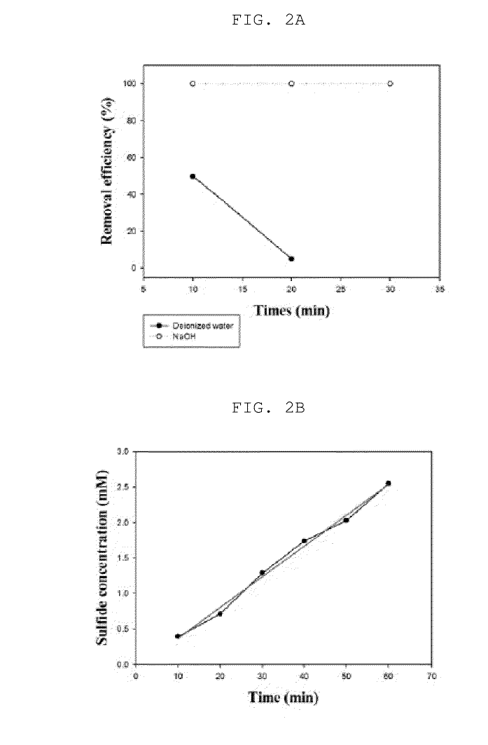

To 100 ml of 0.4 M NaOH solution, 1000 ppm of hydrogen sulfide was fed at a rate of 20 ml/min. The concentration of hydrogen sulfide found in the outlet was measured over time using a Kitagawa H₂S detection tube (Komyo Rikagaku Kyo K.K). Based on the measured concentration, the absorption rate (%) of hydrogen sulfide was calculated. Also, the concentration of dissolved sulfide ion in the NaOH solution was measured using a UV-VIS spectrophotometer (DR 5000, Hach). As can be seen in FIG. 2A showing the removal rate as a function of time, the hydrogen sulfide was 100% absorbed into the alkaline solution. As can be seen in FIG. 2B, the 100% dissolved hydrogen sulfide led to a linear increase in the concentration of sulfide ion in the NaOH solution.

### Example 2

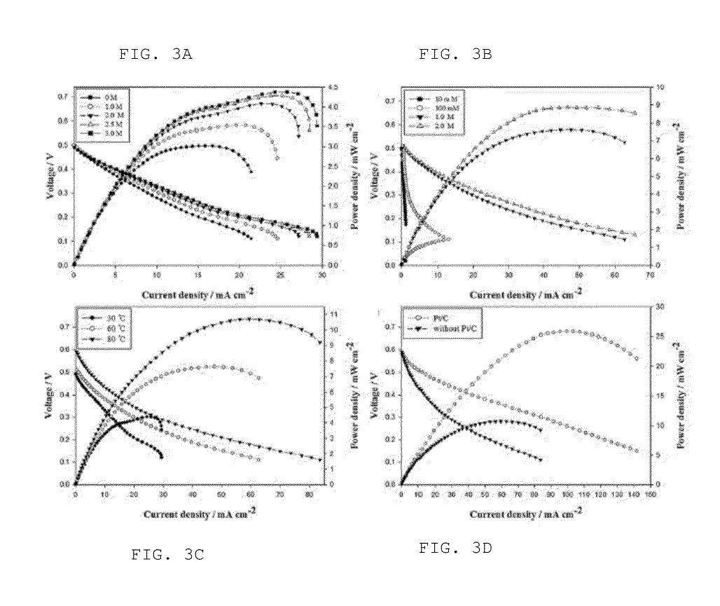

In order to examine the influence of various variables on the electrical performance of a direct alkaline sulfide fuel cell that was not coated with an anode catalyst, various variables were controlled. FIG. 3A is a graph showing the electrical performance of the fuel cell as a function of the concentration of NaOH when 1 M Na₂S solution was used as fuel at room temperature. As can be seen therein, the electrical output increased as the NaOH concentration increased. FIG. 3B is a graph showing the electrical performance as a function of the concentration of Na₂S in 3 M NaOH solution at room temperature. As can be seen therein, the electrical output increased as the Na₂S concentration increased.

FIG. 3C shows the electrical performance of the fuel cell as a function of temperature when 1 M Na₂S+3 M NaOH solution was used as fuel. As can be seen therein, the electrical output increased as the temperature increased. FIG. 3D is a graph showing the electrical performance of the fuel cell in the presence and absence of the anode catalyst when 1 M Na₂S+3 M NaOH solution was used as fuel at 70° C. As can be seen therein, the presence of the platinum catalyst increased the electrical output.

### Example 3

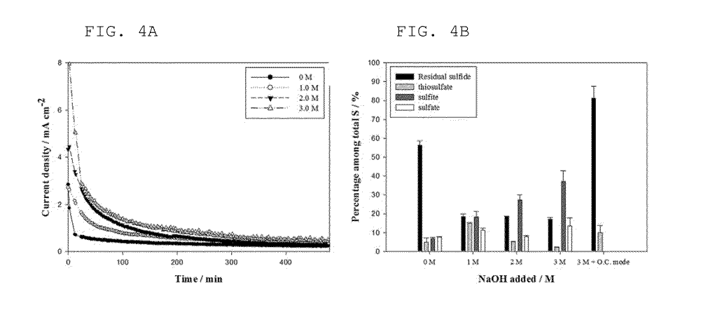

In order to examine the final products of the direct alkaline sulfide fuel cell as a function of alkalinity, 3 mM Na₂S was used as fuel in the direct alkaline sulfide fuel cell that was not coated with the anode catalyst, and the current during 8-hour operation of the fuel cell and the final products of the fuel cell as a function of NaOH were measured. The current during 8-hour operation is shown in FIG. 4A, and the final products after 8-hour operation are shown in FIG. 4B. As can be seen therein, as the alkalinity increased, the current density increased because the oxidation of the fuel occurred faster. In addition, as the alkalinity increased, higher-oxidation state ions were more predominant.

### Example 4

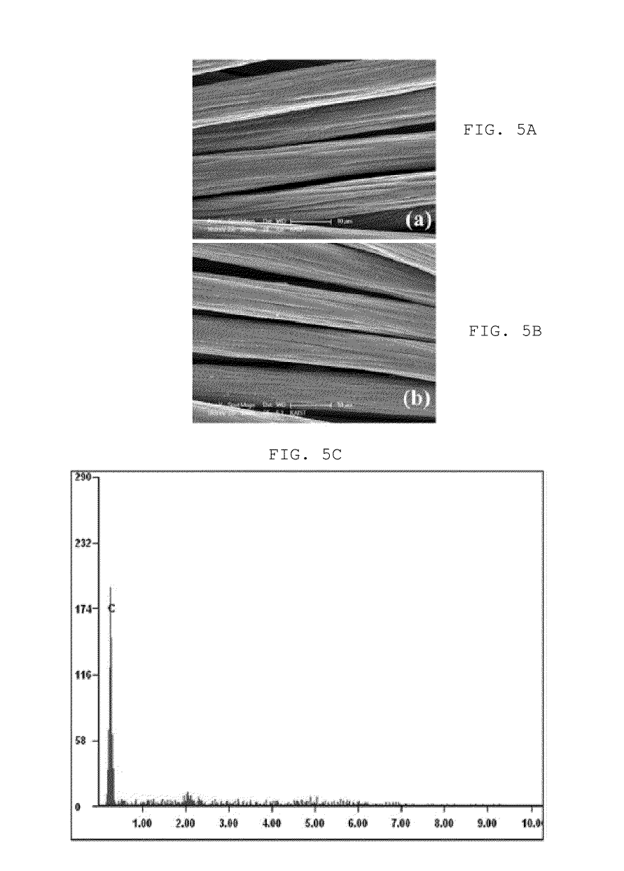

In order to examine whether 3 mM Na₂S used as fuel poisons the electrode of a direct alkaline sulfide fuel cell that was not coated with an anode catalyst, a SEM photograph of the electrode was taken before the operation of the fuel cell and after the 8-hour operation of the fuel cell. FIG. 5 shows the SEM photographs. As can be seen therein, the electrode was not poisoned, suggesting that the electrode was stably maintained during the operation.

### Example 5

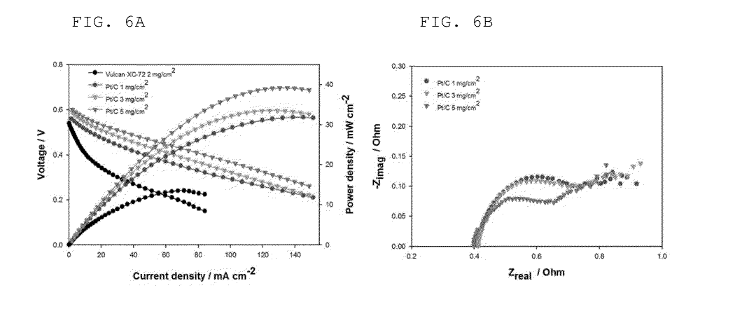

1 M Na₂S+3 M NaOH solution was used as fuel at 70° C. in direct alkaline sulfide fuel cells coated with varying amounts of platinum as an anode catalyst, and the electrical performance of the fuel cell coated with each amount of the platinum catalyst was measured. The results of the measurement are shown in FIG. 6. As can be seen therein, as the amount of platinum catalyst increased, the output of electrical energy increased and the internal resistance of the fuel cell decreased.

### Example 6

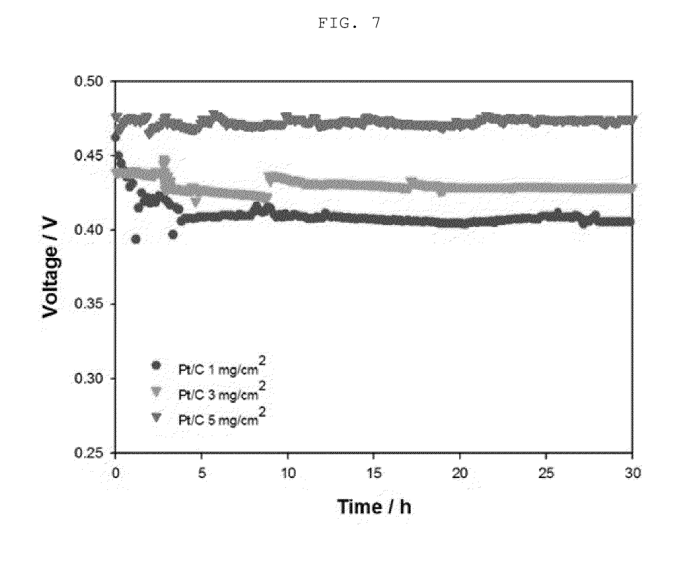

1 M Na₂S+3 M NaOH solution was used as fuel at 70° C. in direct alkaline sulfide fuel cells coated with varying amounts of platinum as an anode catalyst, and the output of electrical energy for 30-hour operation of the fuel cell coated with each amount of the platinum catalyst was measured. The results of the measurement are shown in FIG. 7. As can be seen therein, poisoning did not occur during 30-hour operation, electrical energy was securely produced, and the amount of electricity produced increased as the amount of platinum catalyst coated increased.

### Example 7

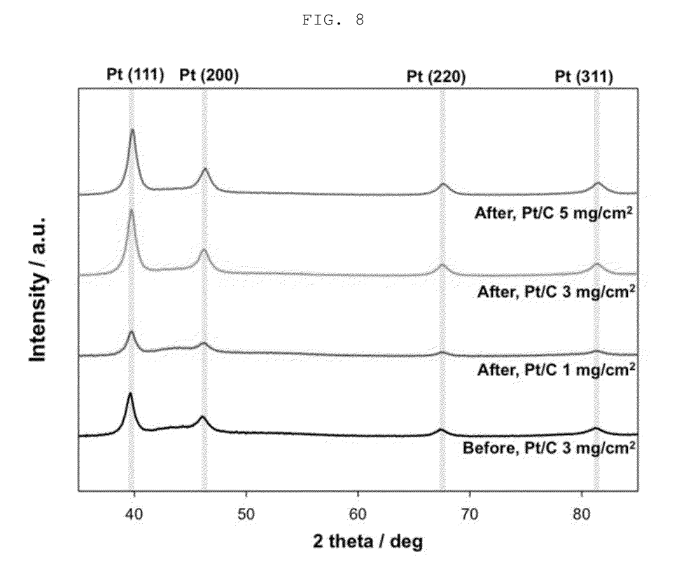

1 M Na₂S+3 M NaOH solution was used as fuel at 70° C. in direct alkaline sulfide fuel cells coated with varying amounts of platinum as an anode catalyst, and the fuel cell coated with each amount of the platinum catalyst was operated for 30 hours, after which the platinum catalyst was analyzed by XRD. The results of the analysis are shown in FIG. 8. As can be seen therein, the platinum catalyst was securely maintained even after 30 hours of the operation, and impurities such as platinum sulfide (PtS) were not produced.

### Example 8

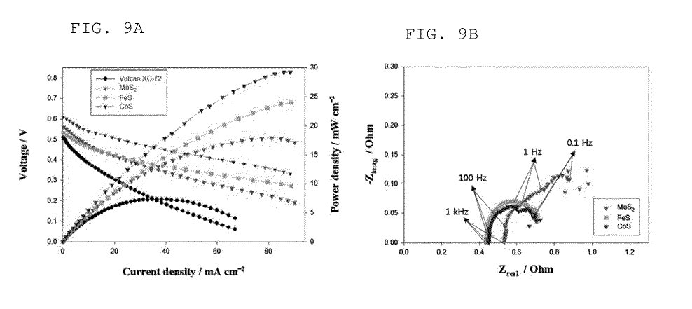

1 M Na₂S+3 M NaOH solution was used as fuel at 70° C. in direct alkaline sulfide fuel cells coated with various metal sulfides (molybdenum sulfide, iron sulfide, and cobalt sulfide) as anode catalysts, and the electrical performance of the fuel cell coated with each catalyst was measured. The results of the measurement are shown in FIG. 9. As can be seen therein, the metal sulfides acted as catalysts, and among them, cobalt sulfide showed the highest production of electrical energy.

### Example 9

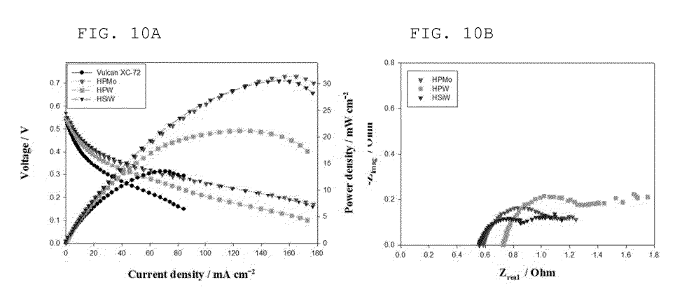

1 M Na₂S+3 M NaOH solution was used as fuel at 70° C. in direct alkaline sulfide fuel cells coated with various heteropolyacids (molybdophosphate, tungsten phosphate, and silicon tungstate) as anode catalysts, and the electrical performance of the fuel cell coated with each catalyst was measured. The results of the measurement are shown in FIG. 10. A can be seen therein, the heteropolyacids acted as catalysts, and among them, molybdophosphate and silicon tungstate showed the high production of electrical energy.

### Example 10

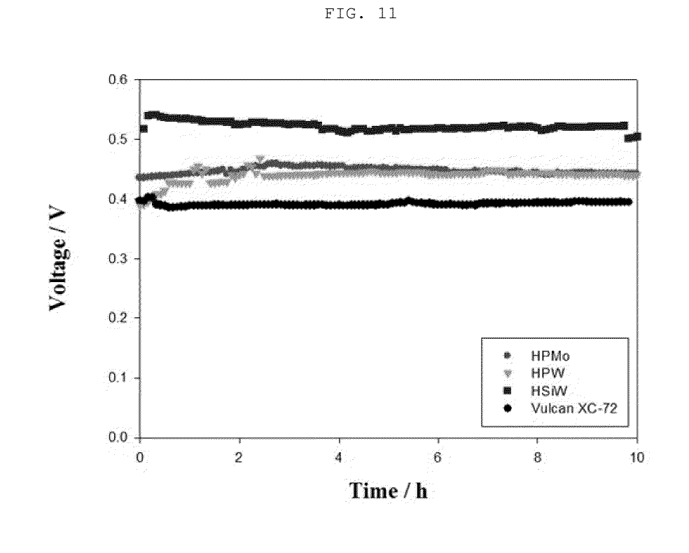

1 M Na₂S+3 M NaOH solution was used as fuel at 70° C. in direct alkaline sulfide fuel cells coated with various heteropolyacids (molybdophosphate, tungsten phosphate, and silicon tungstate) as anode catalysts, and the production of electrical energy in the fuel cell coated with each catalyst was measured for 10 hours. The results of the measurement are shown in FIG. 11. As can be seen therein, electrical energy was securely produced for 10 hours.

### Example 11

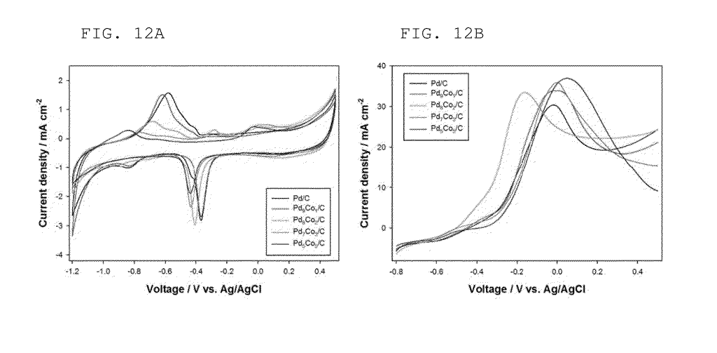

Using glassy carbon electrodes coated with palladium-cobalt binary alloys having various Pd/Co ratios (Pd:Co=9:1, 8:2, 7:3, and 5:5), cyclic voltammetry of each of 3 M NaOH solution and 1 M Na₂S+3 M NaOH at room temperature was performed. The results of the cyclic voltammetry are shown in FIG. 12. As can be seen therein, a hydroxyl group (OH) was more easily adsorbed onto the alloy as the ratio of cobalt in the alloy increased, and this adsorption influenced the oxidation of sulfide ion. In addition, it was shown that, when the ratio of palladium to cobalt was 8:2, the oxidation of sulfide ion was optimized.

### Example 12

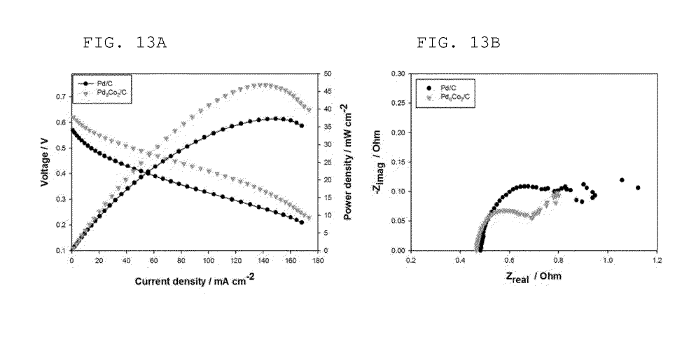

1 M Na₂S+3 M NaOH solution was used as fuel at 70° C. in direct alkaline sulfide fuel cells coated with palladium-cobalt binary alloys having Pd:Co ratios of 1:1 and 8:2, and the electrical performance of the fuel cell at each palladium/cobalt ratio was measured. The results of the measurement are shown in FIG. 13. It was shown that, at the palladium: cobalt ratio of 8:2, the production of electrical energy was the highest, and the lowest internal resistance was observed.

The fuel that is used in the present invention can be used as a new alternative energy source, because it has advantages over various conventional fuels (hydrogen, methanol, etc.) in that it is inexpensive and advantageous for storage and transportation. Further, it can be used in fuel cell systems that have been widely used in the prior art, and thus can be easily commercialized. In addition, because the fuel of the present invention can securely produce energy over a long period of time without poisoning that is the biggest problem occurring when hydrogen sulfide is used as fuel, it can realize energy self-sufficiency using hydrogen sulfide. Additionally, thiosulfate, sulfite, sulfate and the like, which are produced by a fuel cell using the fuel of the present invention, can be used in various processes, including fertilizer production processes.

Although the present invention has been described in detail with reference to the specific features, it will be apparent to those skilled in the art that this description is only for a preferred embodiment and does not limit the scope of the present invention. Thus, the substantial scope of the present invention will be defined by the appended claims and equivalents thereof.

What is claimed is:

1. A method of removing hydrogen sulfide, the method comprising:
(a) absorbing hydrogen sulfide into an alkaline aqueous solution, thereby producing sulfide ion; and
(b) electrochemically oxidizing the solution comprising the sulfide ion produced in the step (a), thereby producing sulfate ion.

2. The method of claim 1, wherein the alkaline aqueous solution is an aqueous solution of an alkaline metal salt.

3. The method of claim 1, wherein the alkaline aqueous solution is selected from the group consisting of sodium hydroxide and potassium hydroxide.

4. The method of claim 1, wherein the solution containing the sulfide ion is used as an electrolytic solution in an anode of a fuel cell in the step of electrochemically oxidizing the solution.

5. The method of claim 1, wherein pH of the solution in the step (b) is 12-14.

6. The method of claim 1, wherein the sulfate ion is S₂O₃²⁻, SO₃²⁻ or SO₄²⁻.

7. The method of claim 1, wherein a catalyst is added in the step (b) and is one or more selected from the group consisting of a noble metal, a transition metal, a noble metal oxide, a transition metal oxide, a noble metal sulfide, a transition metal sulfide, a noble metal-transition metal binary alloy, and a heteropolyacid and its salt.

8. The method of claim 7, wherein the noble metal is gold, silver, platinum or palladium; the transition metal is nickel, cobalt, iron, manganese, molybdenum or tungsten; and the heteropolyacid and its salt are one or more selected from the group consisting of molybdophosphate (PMo₁₂O₄₀³⁻), tungsten phosphate (PW₁₂O₄₀³⁻), molybdosilicate (SiMo₁₂O₄₀⁴⁻) and tungsten silicate (SiW₁₂O₄₀⁴⁻).

9. The method of claim 1, wherein the step (b) is performed at a temperature between 20° C. and 90° C.

10. The method of claim 1, wherein the concentration of the alkaline aqueous solution is 1-5 M.

11. A hydrogen sulfide removal system comprising:
an H₂S absorption unit comprising an alkaline aqueous solution for absorbing hydrogen sulfide to produce sulfide ion; and
a fuel cell unit for oxidizing the solution comprising the sulfide ion produced in the absorption unit.

12. A method of removing hydrogen sulfide and generating electricity, the method comprising:
(a) absorbing hydrogen sulfide into an alkaline aqueous solution to produce sulfide ion; and
(b) feeding the solution comprising the sulfide ion produced in the step (a) into an anode of a fuel cell and producing sulfate ion thereby producing electrical energy.
